(19) United States
(12) Patent Application Publication
(10) Pub. No.: US 2013/0173131 A1
(43) Pub. Date: Jul. 4, 2013

(54) Method for Limiting the Maximum Brake Performance Which Can Be Accessed of a Hydrodynamic Brake

(71) Applicants: Jurgen Betz, Satteldorf (DE); Markus Bischoff, Gaildorf-Ottendorf (DE); Mirco Wassermann (Fick), Michelbach an der Bilz (DE); Thomas Geier, Schwendi (DE)

(72) Inventors: Jurgen Betz, Satteldorf (DE); Markus Bischoff, Gaildorf-Ottendorf (DE); Mirco Wassermann (Fick), Michelbach an der Bilz (DE); Thomas Geier, Schwendi (DE)

(21) Appl. No.: 13/640,277

(22) PCT Filed: Mar. 31, 2011
(86) PCT No.: PCT/EP2011/001624

§ 371 Date: Mar. 19, 2013

(30) Foreign Application Priority Data
Apr. 29, 2010 (DE) 10 2010 018 805.0

(51) Int. Cl. B60T 10/02

(52) U.S. Cl. CPC B60T 10/02
USPC 701/70

(57) ABSTRACT

The invention relates to a method for limiting the maximum braking performance which can be accessed of a hydrodynamic brake in a motor vehicle, wherein the heat which is generated by the hydrodynamic brake is dissipated by means of a cooling system, with the following steps: the temperature of the hydrodynamic brake and/or the cooling system is detected continuously or at time intervals; a regulating intervention temperature is predefined; a regulating target temperature is predefined; if the temperature of the hydrodynamic brake and/or of the cooling system rises to the regulating intervention temperature or above, the maximum braking performance which can be accessed of the hydrodynamic brake is reduced with a predefined gradient, until a predetermined time period has passed and/or until a constant value of the temperature of the hydrodynamic brake and/or of the cooling system is set. The invention is characterized in that a difference between the regulating target temperature and the value of the temperature after the predetermined time period or between the regulating target temperature and the constant value of the temperature of the hydrodynamic brake and/or of the cooling system is determined, and the regulating intervention temperature is shifted as a function of the difference.

The invention relates to a method for limiting the maximum retrievable brake power of a hydrodynamic brake in a motor vehicle, specifically with the steps according to the preamble of claim 1.

There is a likelihood of damage by overheating in the case of a comparatively late or less strong reduction in the brake power of the hydrodynamic brake, especially when the heat generated by a hydrodynamic brake in a motor vehicle is dissipated by means of the “normal” cooling system (which means by the engine cooling circuit with which the drive engine of the vehicle is cooled) and said coolant is revolved in the engine cooling circuit by means of a coolant pump driven by the vehicle drive engine, and the likelihood of an unnecessary reduction in the availability of the hydrodynamic brake on the other hand in the case of a comparatively early or strong reduction in the brake power of the hydrodynamic brake. This conflict of interests is described in detail in the German patent DE 10 2006 036 185 B3.

DE 197 16 922 A1, which is a specification laid open to public inspection, describes a method for limiting the maximum retrievable brake power of a hydrodynamic brake in a motor vehicle in which the control intervention temperature is shifted depending on the temperature progression over time of the cooling medium and/or the working medium of the retarder. The features known from this specification laid open to public inspection are summarized in the preamble of claim 1.

Although numerous methods have been developed for limiting the maximum retrievable brake power with respect to the problems as mentioned above, there is still a need for further improvements. As a result, the availability of the hydrodynamic brake should be increased to the highest possible extent and the risk of temperature overshoot shall securely be excluded at the same time.

It has further been noticed in practice that known methods occasionally have a tendency towards oscillating, accompanied occasionally by a high amplitude of oscillations of the braking torque in the reduction range. The oscillation of the control loop further increases the number of switchings of the switching valves used for triggering, usually the pressure triggering, of the hydrodynamic brake, leading to premature wear and tear.

The present invention is therefore based on the object of providing a method for limiting the maximum retrievable brake power of a hydrodynamic brake, which method is optimized with respect to the availability of the hydrodynamic brake and the risk of temperature overshoot, and in which simultaneously the tendency towards oscillating in the reduction range is reduced.

The object in accordance with the invention is achieved by a method with the features of claim 1. Advantageous and especially appropriate embodiments of the invention are provided in the dependent claims.

The method in accordance with the invention is used for limiting the maximum retrievable brake power of a hydrodynamic brake. Brake power of the hydrodynamic brake will be retrieved in such a way for example that a driver actuates a respective brake lever or sets a specific braking step. Depending on the actuation or the setting which is detected by a control device, said control device triggers the hydrodynamic brake in such a way (by a control air system for example) that a specific quantity of working medium is set in the working chamber of the hydrodynamic brake which leads to the generation of the desired brake power, especially a predetermined braking torque.

The setting of the desired brake power or the braking torque predetermined by the driver or the control apparatus leads to a respective generation of heat in the hydrodynamic brake, wherein the heat needs to be dissipated via a suitable cooling system, e.g. via the engine cooling circuit, either indirectly or directly, and in the latter case in such a way for example that the working medium of the hydrodynamic brake is simultaneously the coolant in the engine cooling circuit. If as a result of a low throughput in the coolant pump which revolves the coolant in the engine cooling circuit and which is driven by the vehicle drive engine there is a likelihood of an impermissible increase in the temperature when setting the brake power required by the driver or the control device, the demand for braking will not be implemented fully. Instead, the maximum retrievable brake power of the hydrodynamic brake represents an upper threshold. As long as the brake power retrieved specifically by the driver or the control device remains beneath said threshold, the demand will be implemented completely. If the specifically retrieved brake power exceeds the said threshold however, only the maximum permissible brake power will be set.

If reference is made in the present case that a control device retrieves brake power, then this can be the case when an automatic control determines on the basis of specific detected operating states of the vehicle or the topography of the route that hydrodynamic braking is advantageous. Said hydrodynamic braking will then be initiated automatically without requiring any active actions on the part of the driver.

The method in accordance with the invention for limiting the maximum retrievable brake power of the hydrodynamic brake in a motor vehicle, wherein the heat generated by the hydrodynamic brake is dissipated by means of a cooling system, provides that the temperature Tᵢₛₜ of the hydrodynamic brake and/or cooling system is detected continuously or in intervals.

Furthermore, a control intervention temperature T₁ is predetermined and a control target temperature T₂.

When the temperature Tᵢₛₜ of the hydrodynamic brake and/or the cooling system rises up to the control intervention temperature T₁ or beyond, the maximum retrievable brake power of the hydrodynamic brake is reduced with a predetermined gradient until a constant value T_{ist,konst} of the temperature of the hydrodynamic brake and/or the cooling system is obtained.

In accordance with the invention, the difference between the control target temperature T₂ and said constant value T_{ist,konst} of the temperature of the hydrodynamic brake and/or the cooling system which has been obtained will be determined, and subsequently the control intervention temperature will be shifted depending on the determined difference. The control intervention temperature will advantageously be shifted upwardly, which means in the direction of larger values, when the control target temperature lies above the constant value, and in a respective downward or toward smaller values when the control target temperature lies beneath the constant value.

It is also possible to wait until a specific time interval of 5 seconds for example has passed in addition or alternatively to waiting until a constant value T_{ist,konst} of the temperature of the high dynamic brake and/or the cooling system has been obtained, and the then prevailing temperature Tᵢₛₜ of the hydrodynamic brake and/or the cooling system can be used for the comparison in accordance with the invention with the control target temperature T₂ and the determination of the difference following therefrom.

This step width of shifting can be determined proportionally to the magnitude of the difference.

It is advantageous when the predetermined gradient of the reduction of the maximally retrievable brake power is kept constant on the basis of the respective currently set control intervention temperature T₁. This can occur in such way for example that the control end temperature T₃ is predetermined with a predetermined distance above the control intervention temperature T₁, which is always shifted together with the control intervention temperature T₁, so that the distance between the control end temperature T₃ and the control intervention temperature T₁ will remain constant. The reduction in the maximum retrievable brake power is 0 percent in the control intervention temperature T₁, which means that the reduction already starts here. In the case of the control end temperature T₃ on the other hand, the reduction in the maximum retrievable brake power is 100 percent, which means any demand for braking torque will be suppressed. A similarly maintained progression can be predetermined between the control intervention temperature T₁ and the control end temperature T₃, especially a linear progression between these two threshold values, so that any shifting of the two threshold values (control intervention temperature and control end temperature) has an immediate effect on the reduction in the maximum retrievable brake power to be set at a current temperature Tᵢₛₜ of the hydrodynamic brake and/or the cooling system.

Usually, the control intervention temperature T₁ and the control end temperature T₃ are predetermined in such a way that the control target temperature lies within the range delimited by these two temperatures, i.e. the so-called temperature band.

In accordance with an advantageous method in accordance with the invention, after the shifting of the control intervention temperature T₁, especially together with the control end temperature T₃, and since a difference was determined between the control target temperature T₂ and the constant value of the temperature T_{ist,konst} or the temperature Tᵢₛₜ after the obtained predetermined duration of the hydrodynamic brake and/or the cooling system, the system waits until a new constant value T_{ist,konst} of the temperature of the hydrodynamic brake and/or the cooling system is obtained or until the predetermined (or a new) time interval has passed. A new constant value T_{ist,konst} will therefore be obtained because the predetermined dimension of the reduction in the maximum retrievable brake power changes with the shifting of the control intervention temperature T₁ and especially the control end temperature T₃. In addition or alternatively, the system may simply wait during the same predetermined time interval (or any other predetermined interval). The difference between the control target temperature T₂ and the then newly obtained constant value T_{ist,konst} or the value Tᵢₛₜ after the predetermined duration of the temperature of the hydrodynamic brake and/or cooling system is then used as the basis for the further shifting of the control intervention temperature T₁, especially together with the control end temperature T₃.

The aforementioned progression of the shifting of the control intervention temperature T₁ advantageously occurs in such a way that the control intervention temperature T₁ and especially the control end temperature T₃ are respectively shifted only one single time and the system then waits at first until the new constant value T_{ist,konst} has been obtained or the predetermined time interval has passed.

In order to prevent an excessively frequent shifting of the control intervention temperature T₁ and to thereby prevent an oscillation of the control loop, it can be provided that upon reaching or falling below a predetermined minimum difference Δₘᵢₙ between the control target temperature T₂ and the constant value T_{ist,konst} of the hydrodynamic brake and/or the cooling system any further shifting will be omitted until a maximum difference Δₘₐₓ which is larger in comparison with the minimum difference Δₘᵢₙ is obtained between the control target temperature T₂ and the value Tᵢₛₜ of the hydrodynamic brake and/or cooling system, whereupon the shifting of the control intervention temperature T₁, especially together with the control end temperature T₃, will be continued again on the basis of said maximum difference Δₘₐₓ. The same also applies to the alternative in that the system waits a predetermined time interval, without a constant value T_{ist,konst} of the temperature already having been obtained.

This minimum difference Δₘᵢₙ can be ±0.1° C. or ±0.2° C. to ±0.4° C. or ±0.5° C. The maximum difference Δₘₐₓ can be ±0.4° C. or ±0.5° C. to ±0.7° C. or ±0.8° C. It is especially advantageous if the minimum difference Δₘᵢₙ is ±0.2° C. and the maximum difference Δₘₐₓ is +0.5° C. The values of the temperature differences can also be stated in K, with identical amounts. Other values can also be considered.

A value of between 100° C. and 110° C. can be chosen as the control intervention temperature T₁, especially 108° C. (as the starting value of the method). A value of 110° C. to 115° C., especially 112° C., can be chosen as the control target temperature T₂ for example. A value of 115° C. to 120° C. can be used for example as the control end temperature T₃.

The temperature of the hydrodynamic brake can be detected as the temperature Tᵢₛₜ for the method in accordance with the invention in such a way that the temperature of the working medium of the hydrodynamic brake will be used. When the temperature of the cooling system is detected as the temperature Tᵢₛₜ, the temperature of the coolant of an engine cooling circuit will advantageously be detected, by means of which the heat generated by the hydrodynamic brake will be dissipated. The coolant of the engine cooling circuit can simultaneously be the working medium of the hydrodynamic brake which transfers torque from the primary wheel to the secondary wheel by forming a circuit in the working chamber of the hydrodynamic brake between the primary wheel and the secondary wheel. The primary wheel is a bladed rotor. The secondary wheel is a bladed stator or a bladed counter-running rotor.

The invention will be explained below by way of example by reference to an embodiment and the drawings, wherein:

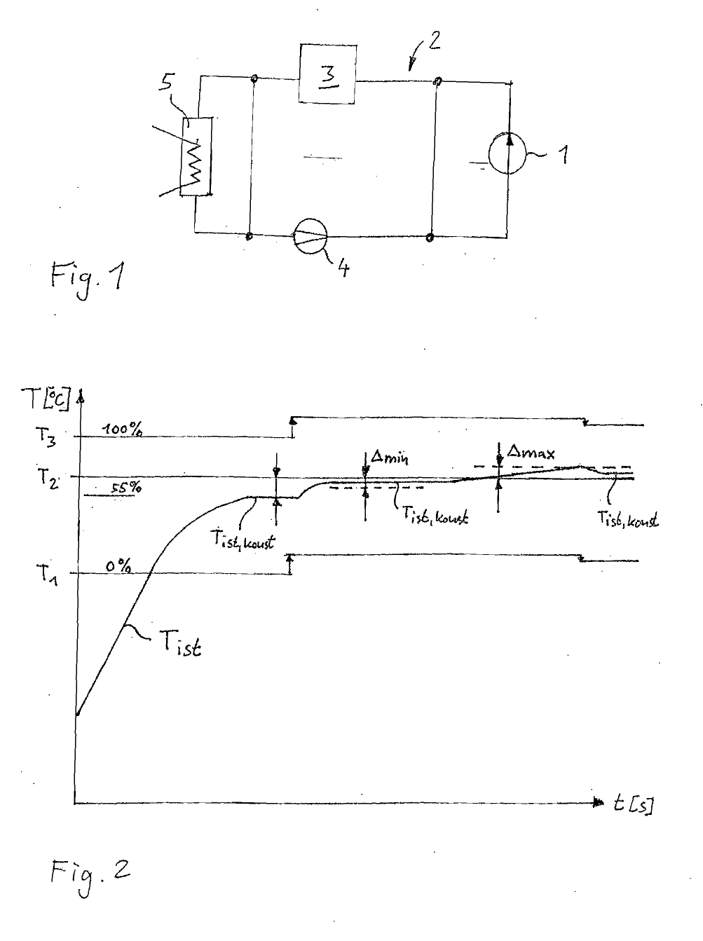

FIG. 1 shows an engine cooling circuit of a motor vehicle with a hydrodynamic brake introduced therein, the maximum retrievable brake power of which can be controlled in a closed-loop or open-loop manner in accordance with the invention;

FIG. 2 shows an embodiment for the temperature presets and their shifting.

FIG. 1 shows a schematic view of an engine cooling circuit 2 of a motor vehicle. A coolant is made to circulate in said engine cooling circuit 2 by means of the coolant pump 4, with said circuit leading through a vehicle radiator 5 (fluid-air heat exchanger) in which heat absorbed from the coolant is dissipated to the ambient environment. The coolant further flows through the vehicle drive engine 3 in order to cool the same, and is the working medium of the hydrodynamic brake 1 arranged in the engine cooling circuit 2.

The arrangement of the various elements in the engine cooling circuit 2 is chosen at random in FIG. 1 and can be arranged in any deviating manner.

FIG. 2 shows a temperature or control progression which is obtained in an embodiment of the method in accordance with the invention. The value Tᵢₛₜ represents the current temperature of the hydrodynamic brake or the cooling system, e.g. the coolant of the engine cooling circuit. When said temperature Tᵢₛₜ exceeds the control intervention temperature T₁, the maximum retrievable brake power will be reduced starting at 0 percent reduction up to 100 percent reduction at control end temperature T₃. With rising temperature Tᵢₛₜ there will therefore be an increasingly stronger reduction until a constant progression of the temperature Tᵢₛₜ is obtained, which is designated here with T_{ist,konst}. In the illustrated embodiment, the reduction of the maximum retrievable brake power is 55 percent in order to obtain the constant progression of the temperature Tᵢₛₜ.

At this constant progression of the temperature T_{ist,konst}, there is still the difference to the comparatively larger control target temperature T₂, which is shown with the perpendicular double arrow on the left.

As a result of this difference, the control intervention temperature T₁ will be shifted upwardly after this difference was determined, together the control end temperature T₃. A new value of the reduction in the maximum retrievable brake power is obtained in this way for the temperature value to which the temperature Tᵢₛₜ has adjusted (T_{ist,konst}), namely a lower reduction of 50 percent for example. As a result of this, the temperature Tᵢₛₜ rises again until a new constant value T_{ist,konst} has been reached. The distance of this new constant value T_{ist,konst} which is shown in the middle of FIG. 2 lies within the predetermined minimum difference Δₘᵢₙ. As a result, there will not be any further shifting of the control intervention temperature T₁ and the control end temperature T₃ for the time being.

If as a result of predetermined boundary conditions the distance changes between the temperature Tᵢₛₜ and the control target temperature T₂ and the maximum difference Δₘₐₓ is reached or exceeded, a renewed shifting of the control intervention temperature T₁ and the control end temperature T₃ will occur. In the illustrated embodiment the temperature Tᵢₛₜ will rise, exceed the control target temperature T₂, and rise further until it reaches the maximum difference Δₘₐₓ. Subsequently, the control intervention temperature T₁ is shifted downwardly together with the control end temperature T₃, so that a new constant temperature T_{ist,konst} is obtained, which is shown in FIG. 2 on the right-hand side.

Deviating from the progression of the temperature Tᵢₛₜ as shown in FIG. 2, which remains constant in the mentioned states (T_{ist,konst}), the system may also wait a predetermined period of time until the difference is determined, irrespective of whether the temperature has reached a constant value in this time interval.

1-10. (canceled)

11. A method for limiting the maximum retrievable brake power of a hydrodynamic brake in a motor vehicle, with the heat generated by the hydrodynamic brake being dissipated by means of a cooling system, comprising the following steps:
the temperature of the hydrodynamic brake and/or the cooling system is detected continuously or in time intervals;
a control intervention temperature is predetermined;
a control target temperature is predetermined;
when the temperature of the hydrodynamic brake and/or the cooling system rises up to the control intervention temperature or beyond, the maximum retrievable brake power of the hydrodynamic brake will be reduced with a predetermined gradient until a predetermined time interval has passed and/or until a constant value of the temperature of the hydrodynamic brake and/or the cooling system is obtained;
characterized in that
a difference is determined between the control target temperature and the value of the temperature after the predetermined time interval or between the control target temperature and the constant value of the temperature of the hydrodynamic brake and/or the cooling system, and the control intervention temperature is shifted depending on the difference.

12. The method according to claim 11, characterized in that the predetermined gradient of the reduction of the maximum retrievable brake power is kept constant on the basis of the respective control intervention temperature.

13. The method according to claim 12, characterized in that a control end temperature is predetermined with a predetermined distance above the control intervention temperature, which control end temperature is shifted together with the control intervention temperature, with the control intervention temperature and the control end temperature being predetermined in such a way that the control target temperature always lies within the temperature band limited by the control intervention temperature and the control end temperature, and the gradient of the reduction of the maximum retrievable brake power is predetermined in such a way that the reduction of the maximum retrievable brake power is 0 percent in the control intervention temperature and 100 percent in the control end temperature, especially with a linear progression between these two limit values.

14. The method according to claim 11, characterized in that after the shifting of the control intervention temperature, especially together with the control end temperature, the system waits at first until a predetermined time interval has passed again and/or until a new constant value of the temperature of the hydrodynamic brake and/or the cooling system is obtained, and the difference between the control target temperature and the value of the temperature after the predetermined time interval or between the control target temperature and the new constant value of the temperature of the hydrodynamic brake and/or the cooling system is used as the basis for further shifting.

15. The method according to claim 12, characterized in that after the shifting of the control intervention temperature, especially together with the control end temperature, the system waits at first until a predetermined time interval has passed again and/or until a new constant value of the temperature of the hydrodynamic brake and/or the cooling system is obtained, and the difference between the control target temperature and the value of the temperature after the predetermined time interval or between the control target temperature and the new constant value of the temperature of the hydrodynamic brake and/or the cooling system is used as the basis for further shifting.

16. The method according to claim 13, characterized in that after the shifting of the control intervention temperature, especially together with the control end temperature, the system waits at first until a predetermined time interval has passed again and/or until a new constant value of the temperature of the hydrodynamic brake and/or the cooling system is obtained, and the difference between the control target temperature and the value of the temperature after the predetermined time interval or between the control target temperature and the new constant value of the temperature of the hydrodynamic brake and/or the cooling system is used as the basis for further shifting.

17. The method according to claim 14, characterized in that upon reaching or falling below a predetermined minimum difference between the control target temperature and the value of the temperature after the predetermined time interval or between the control target temperature and the constant value of the temperature of the hydrodynamic brake and/or the cooling system any further shifting is suspended until a maximum difference which is larger in comparison with the minimum difference is obtained between the control target temperature and the temperature of the hydrodynamic brake and/or the cooling system, whereupon the shifting of the control intervention temperature, especially together with the control end temperature, is continued.

18. The method according to claim 15, characterized in that upon reaching or falling below a predetermined minimum difference between the control target temperature and the value of the temperature after the predetermined time interval or between the control target temperature and the constant value of the temperature of the hydrodynamic brake and/or the cooling system any further shifting is suspended until a maximum difference which is larger in comparison with the minimum difference is obtained between the control target temperature and the temperature of the hydrodynamic brake and/or the cooling system, whereupon the shifting of the control intervention temperature, especially together with the control end temperature, is continued.

19. The method according to claim 16, characterized in that upon reaching or falling below a predetermined minimum difference between the control target temperature and the value of the temperature after the predetermined time interval or between the control target temperature and the constant value of the temperature of the hydrodynamic brake and/or the cooling system any further shifting is suspended until a maximum difference which is larger in comparison with the minimum difference is obtained between the control target temperature and the temperature of the hydrodynamic brake and/or the cooling system, whereupon the shifting of the control intervention temperature, especially together with the control end temperature, is continued.

20. The method according to claim 11, characterized in that the temperature of the working medium of the hydrodynamic brake is detected as the temperature of the hydrodynamic brake.

21. The method according to claim 12, characterized in that the temperature of the working medium of the hydrodynamic brake is detected as the temperature of the hydrodynamic brake.

22. The method according to claim 13, characterized in that the temperature of the working medium of the hydrodynamic brake is detected as the temperature of the hydrodynamic brake.

23. The method according to claim 14, characterized in that the temperature of the working medium of the hydrodynamic brake is detected as the temperature of the hydrodynamic brake.

24. The method according to claim 15, characterized in that the temperature of the working medium of the hydrodynamic brake is detected as the temperature of the hydrodynamic brake.

25. The method according to claim 16, characterized in that the temperature of the working medium of the hydrodynamic brake is detected as the temperature of the hydrodynamic brake.

26. The method according to claim 17, characterized in that the temperature of the working medium of the hydrodynamic brake is detected as the temperature of the hydrodynamic brake.

27. The method according to claim 11, characterized in that the temperature of a coolant of an engine cooling circuit is detected as the temperature of the cooling system, with the heat generated by the hydrodynamic brake being dissipated by means of the coolant of the engine cooling circuit.

28. The method according to claim 27, characterized in that the coolant of the engine cooling circuit is simultaneously the working medium of the hydrodynamic brake.

29. The method according to claim 11, characterized in that the control intervention temperature is shifted to a comparatively lower value, especially together with the control end temperature, at a constant value of the temperature or at a value of the temperature after a predetermined time interval of the hydrodynamic brake and/or the cooling system above the control target temperature, and the control intervention temperature, especially together with the control end temperature, is shifted to a comparatively larger value at a constant value of the temperature or at a value of the temperature after a predetermined time interval of the hydrodynamic brake and/or the cooling system beneath the control target temperature.

30. The method according to claim 29, characterized in that the step width of the shifting is determined proportionally to the difference.
